(19) United States
(12) Patent Application Publication
(10) Pub. No.: US 2014/0372557 A1
(43) Pub. Date: Dec. 18, 2014

(54) System and Method for Adaptation of Capability Discovery for a Multitude of Transport Protocol Requirements/Scenarios Through Interworking

(71) Applicant: Research In Motion Limited, Waterloo (CA)

(72) Inventors: Adrian Buckley, Tracy, CA (US); Brian Edward McColgan, Toronto (CA); Alexander Shatsky, Vaughn (CA)

(21) Appl. No.: 13/920,789

(22) Filed: Jun. 18, 2013

(51) Int. Cl. H04L 29/08

(52) U.S. Cl. CPC H04L 67/104
USPC 709/217

(57) ABSTRACT

A method for communicating service capability information is provided. The method comprises receiving, by a network entity, a message that indicates that a sender of the message is an RCS client, wherein the message includes a list of the sender's client capabilities and a list of contacts about whom the sender wishes to receive presence-related information; establishing, by the network entity, a presence context based on the sender being an RCS client and the list of client capabilities and contacts of the sender; using, by the network entity, the presence context to monitor events in a network; and conveying, by the network entity, information regarding the monitored events to at least one device in the network.

### BACKGROUND

As used herein, terms such as “device” or “mobile device” may refer to transportable devices such as mobile telephones, smartphones, personal digital assistants, handheld, tablet, nettop, or laptop computers, a USB device/dongle, and similar devices that have telecommunications capabilities. In other cases, such terms might refer to devices that have similar capabilities but that are not transportable, such as desktop computers, set-top boxes, or network appliances. Such terms can also refer to any hardware or software component that can terminate a communication session for a user. Other possible synonyms for such a device may include mobile station, MS, user equipment, UE, target entity, wireless device, network endpoint target entity, end point, end device, destination, subscriber, user, destination subscriber/user, terminating subscriber/user, session initiation protocol (SIP) user agent (UA), or Rich Communication Suite (RCS) client.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a client capability discovery mechanism call flow, according to the prior art.

FIG. 2 illustrates another client capability discovery mechanism call flow, according to the prior art.

FIG. 3 illustrates another client capability discovery mechanism call flow, according to the prior art.

FIG. 4 illustrates another client capability discovery mechanism call flow, according to the prior art.

FIG. 5 is a table of interworking scenarios for capability discovery, according to the prior art.

FIG. 6 illustrates an enhanced capability management function according to an embodiment of the disclosure.

FIG. 7 illustrates message flows for an enhanced capability management function according to an embodiment of the disclosure.

FIG. 8 illustrates contact data for an enhanced capability management function according to an embodiment of the disclosure.

FIG. 9 illustrates a contact data response for an enhanced capability management function according to an embodiment of the disclosure.

FIG. 10 illustrates a procedural flow for an enhanced capability management function according to an embodiment of the disclosure.

FIG. 11 illustrates an enhanced capability management function retrieving a contact list according to an embodiment of the disclosure.

FIG. 12 illustrates a protocol example for an enhanced capability management function according to an embodiment of the disclosure.

FIG. 13 illustrates a protocol example for an enhanced capability management function according to another embodiment of the disclosure.

FIG. 14 illustrates a protocol example for an enhanced capability management function according to another embodiment of the disclosure.

FIG. 15 illustrates an alternative message flow for an enhanced capability management function according to an embodiment of the disclosure.

FIG. 16 illustrates an alternative procedural flow for an enhanced capability management function according to an embodiment of the disclosure.

FIG. 17 illustrates another alternative message flow for an enhanced capability management function according to an embodiment of the disclosure.

FIG. 18 illustrates an enhanced capability management function with a presence access layer according to an embodiment of the disclosure.

FIG. 19 illustrates a message flow for an enhanced capability management function with a presence access layer according to an embodiment of the disclosure.

FIG. 20 is a simplified block diagram of an exemplary network element according to one embodiment.

FIG. 21 is a block diagram with an example user equipment capable of being used with the systems and methods in the embodiments described herein.

FIG. 22 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Embodiments of the present disclosure provide methods for establishing the capabilities of one or more of a user's contacts associated with at least one service, such as instant messaging for the Rich Communication Suite or RCS, through an enhanced capability management function. The enhanced capability management function is designed to reduce user/client complexity, increase scalability, and detect events occurring unbeknownst to, for example, the RCS user/client operating within a service provider's network. An RCS client or RCS device may also be referred to herein as an RCS user.

The GSMA (GSM (Global System for Mobile Communications) Association) has led the development of an interoperable, all-IP (internet protocol)-based mobile communication service-suite known as RCS. RCS leverages communication services, such as instant messaging (IM), group chat, voice, file sharing, and conversation history, on behalf of mobile network subscribers or users. RCS functionality is centered around a device's address list, which may be hosted in the network. Interaction with an RCS service is initiated through a device's address list to RCS-capable contacts, such as a one-to-one IM session between RCS devices Alice (Device A) and Bob (Device B).

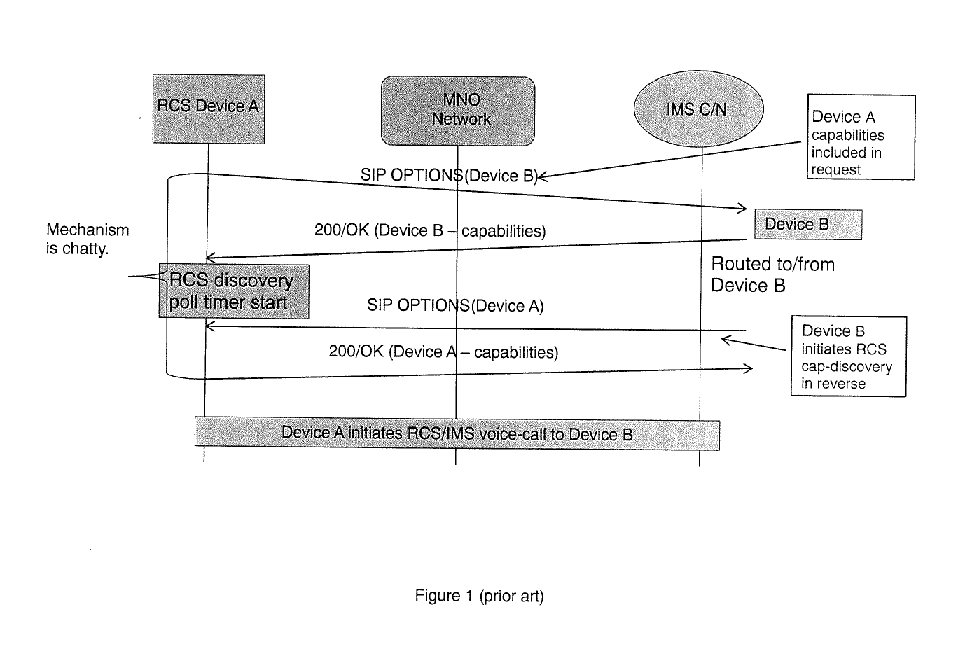

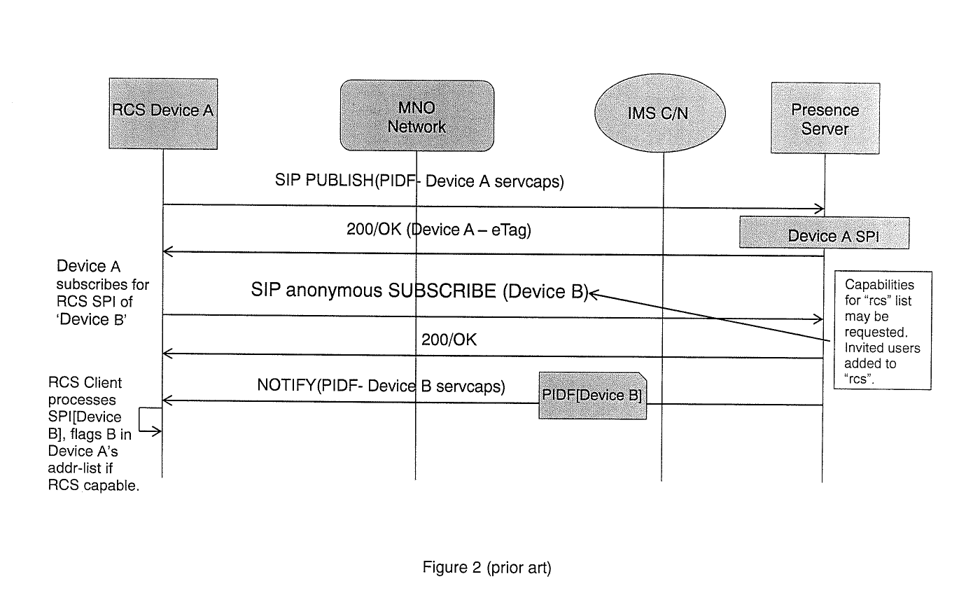

To further detect whether a given contact uses RCS and to determine the RCS services the contact supports, RCS clients utilize a feature known as ‘capability discovery’. A mandatory RCS client capability discovery mechanism involves exchanging peer-to-peer (P2P) SIP:OPTIONS messages between two devices, as illustrated in FIG. 1. An optional and alternative RCS client capability discovery mechanism involves the use of presence information (also referred to by GSMA as social presence information or SPI) to establish another device's RCS capabilities and supported services. For example, device Alice may subscribe for the capabilities of one or more devices from Alice's address list utilizing a tag of ‘+g.3gpp.iari-ref=“urn%3Aurn-7%3A3gpp-application.ims.iari.rcse.dp”’, as shown by the third arrow (from RCS Device A to the Presence Server) in FIG. 2. As used herein, the term “capabilities” may refer to a set of device capabilities required to utilize a particular communication service. Such information may include a poll-timer or cache control directive which, if set to a specific value, indicates how a requestor establishes the capabilities of other devices. Communication services may be expressed as, but are not limited to, tokens, tags, header values, headers, etc., within messages described herein.

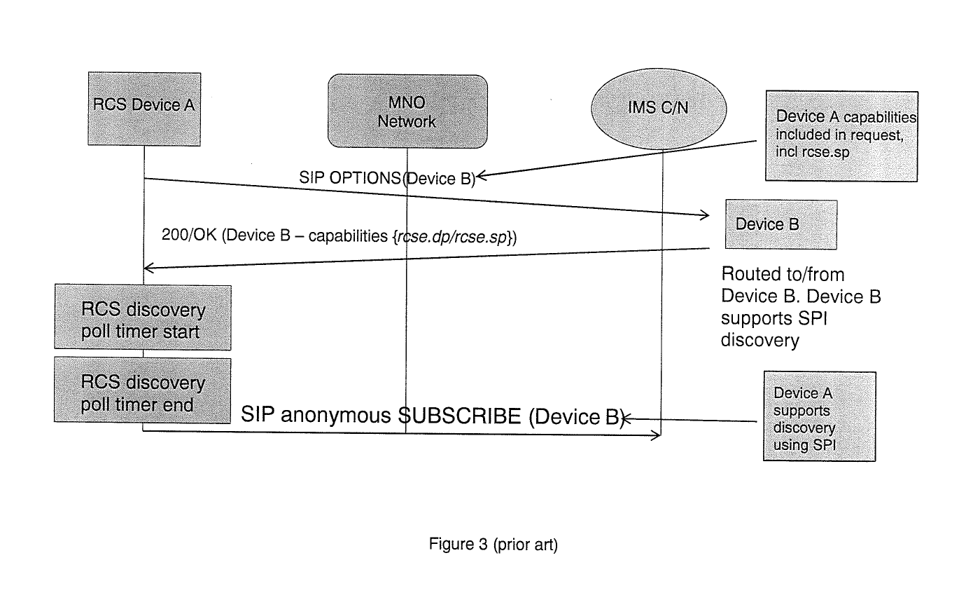

A variation of the two mechanisms may also be employed by an RCS client in order to enhance the baseline P2P capability discovery function. This variant supplements the SIP:OPTIONS mechanism through the use of presence information received as a result of subscribing for service capability information. For example, device Alice may anonymously subscribe for the capabilities of one or more devices from Alice's address list utilizing a tag of ‘+g.3gpp.iari-ref=“urn%3Aurn-7%3A3gpp-application.ims.iari.rcse.sp”’, as shown in the third or last arrow, originating from RCS Device A (device Alice) in FIG. 3.

RCS service capability establishment based on a given run condition (RC) defined in the RCS specifications may occur via a P2P SIP:OPTIONS exchange, as shown in FIG. 1. An RC is a concept in RCS whereby a particular action or sequence of actions occurs. For example, a voice over IP (VoIP) voice call initiated from Device A to Device B is an RC for service capability discovery in RCS. The SIP protocol message flow in FIG. 1 is based on an RC and results in RCS service capabilities being exchanged in both directions, i.e., from Device A to Device B and vice versa. It is possible that an RCS service may be initiated (e.g., an IM session may be initiated) prior to the RCS discovery poll timer expiring (e.g., reaching zero ‘0’). The result is that another RC is invoked, and hence a series of SIP:OPTIONS exchanges occur once again between Device A and Device B. The RCS discovery poll timer may exist on either Device A or Device B, but for brevity only Device A's poll timer is shown in FIG. 1. As a result of the poll timer expiring (a distinct RC), a further set of P2P discovery exchanges are initiated, this time from Device B toward Device A. As with the initial P2P exchange, Device B's capabilities are included in the outgoing SIP:OPTIONS request. The various RCs and the bi-directional nature of the P2P mechanism clearly illustrate the chattiness (i.e., volume of network traffic) that results with various RCS services and the supporting RCS RCs.

Capability discovery based on the optional subscription for social presence information may be controlled through a configuration element provisioned to the RCS client. It may be assumed that Device A will publish Device A's social presence information (SPI) for RCS to the presence server within Device A's IP multimedia subsystem (IMS) core network. This is shown by the first two arrows of FIG. 2. Following successful publication, Device A may begin requesting the SPI of contacts in Device A's contact list, as shown in the subsequent anonymous subscription request from RCS Device A to the Presence Server in FIG. 2.

As a result of an anonymous subscription for the SPI of Device B, Device A may receive a SIP:NOTIFY containing service capability information in the form of a presence information data format (PIDF) document. Device A's RCS client requires a watcher-agent to decipher the received PIDF document on behalf of Device A's RCS client. As a result, an SPI-based capabilities exchange may be more involved than a P2P-based capabilities exchange in terms of messages and processing overhead by the client/UE.

FIG. 3 demonstrates a capabilities discovery variant, utilizing both RCS client P2P and SPI mechanisms, as outlined in FIGS. 1 and 2. In this enhanced mode, a P2P SIP:OPTIONS request may first be made from the RCS client of Device A (containing tag rcse.sp) to at least one contact in Device A's contact list, e.g., Device B. As with conventional P2P capability discovery, both Device A's RCS client and Device B's RCS client exchange service capabilities. As shown in FIG. 3, both Device A and Device B determine via P2P that their RCS clients both support capability discovery through SPI based on the hybrid scheme. As a result, the next time Device A's RCS client refreshes service capabilities with Device B, for example when an RC such as the expiration of an RCS poll timer occurs, an anonymous subscribe may be issued by Device A's RCS client for the capability information of Device B.

Both source and target users of capability discovery typically must indicate a tag of ‘rcse.sp’ for the hybrid mechanism to be invoked. This mechanism may function independently of RCS configuration parameters issued to the respective RCS clients, i.e., for establishing P2P vs. SPI as the baseline service capability.

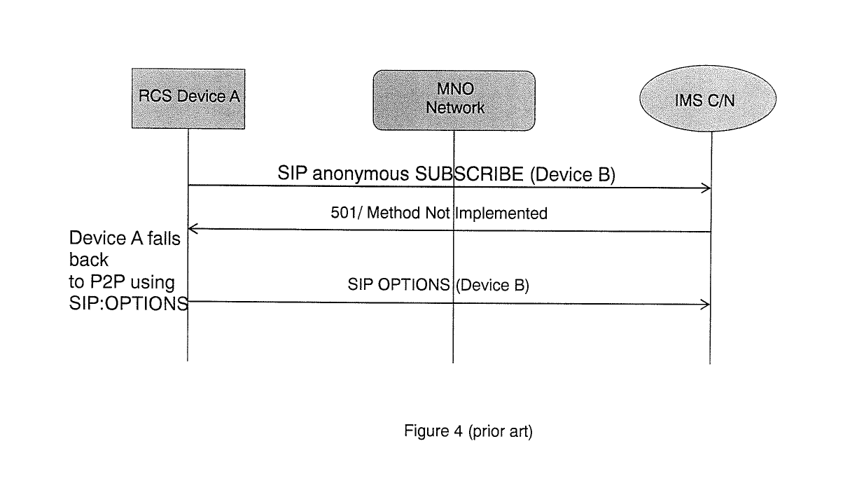

If SPI is not supported by a mobile network operator's (MNO's) network, an RCS service capability discovery that is initiated for a given contact in Device A's contact list and is based on SPI may result in the requesting RCS client receiving a 501 SIP message response. This flow is illustrated in FIG. 4. In this situation and as a result of receiving the 501 SIP message response, Device A's RCS client may attempt to ‘fall back’ to P2P/SIP:OPTIONS directly with Device B for RCS service capability discovery. This flow resulting from Device A's RCS client receiving a 501 response is also illustrated in FIG. 4.

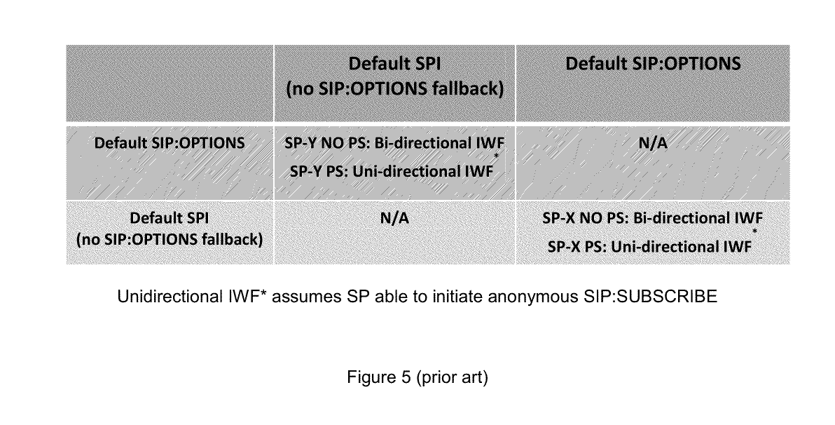

In scenarios in which capability discovery requests traverse networks of different MNO's, support may become further complicated. The increased complexity may be due in part to each MNO's network establishing a baseline capability discovery mechanism for devices and their RCS clients within the MNO's network. Therefore, when capability exchange requests travel from MNO/network X to MNO/network Y, it is possible that one network (e.g., network X) may use a capability discovery mechanism incompatible with the other network (e.g., network Y). RCS specifications indicate that an interworking function (IWF) may be defined, which adapts the mechanisms between two MNOs for interworking scenarios within RCS. An IWF may be a service capability to support one mechanism working with another mechanism based on adapter/bridge functionality. The various scenarios are outlined in FIG. 5.

As noted above, RCS establishes certain run conditions under which an RCS client invokes RCS service capability discovery. These run conditions may be applied to one or more contacts in an RCS device's contact list and may include one or more of the following invocation scenarios: an RCS client first-time start for a given device, where a list of contacts is scanned; a case where all contacts have no capabilities or have expired information, assuming a non-zero polling period; a modification of a contact in the contact list; a case where a contact list owner and a contact on the contact list are about to engage in an RCS communication service (e.g., a voice call); and/or a case where a new contact is added to the contact list, including the manual addition of a contact, a contact list owner synchronizing with a third-party service (e.g., Plaxo, Google contacts, etc.), or an automatic addition via Bluetooth™, QR-code, or other mechanism such as importing a vCard.

The current RCS service capability discovery mechanism may have several drawbacks, which may be further complicated by the inclusion of network-to-network interconnection requirements. These drawbacks may include complexity and availability, inefficient bandwidth utilization and overall solution scalability, and an inability to reconcile service capability indications under changing network and RCS client conditions. Each of these issues will now be considered in more detail.

RCS service capability discovery by an RCS client on behalf of an RCS-capable device may add considerable processing overhead, as described above. This processing overhead may include adding processing elements for several function points outlined in the RCS specification, such as support for and detection of at least a subset of RCS run conditions, correctly decoding service capabilities exchanged with communication partners including the hybrid P2P/SPI variant described above, and the availability of and support for interworking functionality in the IMS core network. Adding to processing overhead is support for an RCS-specific watcher-agent function, such as being able to deliver ‘RCS relevant’ presence information, where supported, to an RCS client in scenarios in which SPI is configured. Watcher-agent support may be complex, particularly if no watcher-agent that can interface to the running RCS client exists on the other RCS client device. Finally, RCS does not mandate an interworking function, so it may be unclear whether RCS service capability discovery will successfully be performed in certain networks when one or more network boundaries are traversed.

The current RCS service capability discovery procedure may not only increase processing overhead, the procedure may also add increased network bandwidth requirements, particularly as the number of RCS devices increases and the number of entries in a device's contact list grows. An example calculation may demonstrate how the number of messages that are transmitted may become exceedingly large when the current RCS service capability discovery procedure is employed. An RCS device may be assumed to have 50 peer contact entries. On a first-time RCS client start, the RCS device may utilize 150 P2P messages, which may include 50 SIP:OPTIONS messages, 50 SIP 100 Trying provisional messages, and 50 final response codes. When the polling period is non-zero, some or all of these 150 P2P messages, depending on the number of discrete RCS contacts identified as RCS-capable, may be duplicated over the specified polling frequency. For 100 individual RCS devices in the network, 15,000 message exchanges would occur on the network. For 10,000 RCS devices, that number grows to 1,500,000 messages.

Many capability discovery RCs are initiated from within the network without any involvement by an RCS client/user. This makes detecting network-originated scenarios completely invisible to an RCS client device and adds a high degree of processing complexity to an already active RCS client, where the RCS client may be considered ‘active’ if the client device on which the RCS client is running is performing many other functions. This may further add to an RCS client's processing burden. Examples of network (MNO) originated scenarios of which a client device may not be aware include the registration of a new RCS device with an MNO and a third-party contact list synchronization by an RCS-capable device.

The existing RCS service capability discovery procedure may also fail to take into account a scenario where Device A (an RCS-capable device) is a communication peer to RCS Device B and Device C. RCS service capability discovery is currently unable to suggest or auto-invite Device B and Device C based on their common relationship with Device A. The existing RCS service capability discovery procedure may further fail to take into account a scenario where Device B goes out of network coverage, which may cause the network to detect and remove Device B's IMS registration, e.g., at the registrar. However, Device A's RCS client may be unable to detect or be informed of this change unless Device A invokes an RCS RC, for example by attempting to invoke an RCS service with Device B. This can add further network overhead due to network ‘jitter’ (coverage loss) on behalf of one or more RCS communication peers (e.g., Device A). Communication peers are users/devices that are able to support interoperable communication services, manifested over IP (wireless) networks. For example, RCS supports the notion of communication peers—meaning other RCS client devices/users.

As described above, current RCS service capability discovery solutions utilize horizontal network technologies, such as P2P, presence, hybrid P2P/presence, or rudimentary interworking. The RCS implementation procedures promoted by the GSMA rely solely on generic architectural approaches and do not include any concrete, interoperable specifications to deal with the drawbacks outlined above. The generic GSMA approaches may also impact the energy and/or bandwidth efficiency of RCS when deployed on battery powered mobile wireless devices. The GSMA implementation procedures may further impact the ability for RCS to provide scalable IP-based communication services that will evolve with a device's growing contact list. In addition, network service providers may be inhibited from expanding their RCS user/subscriber base. Power, network bandwidth requirements, and other limitations may further limit the broad appeal, user experience, and uptake of RCS. Customers of wireless service providers may seek and adopt alternative, over the top (OTT) type services (e.g., by downloading an application on an application store) based on proprietary or non-interoperable service technologies. A drawback of the OTT approach is that consumers may be limited to solutions that restrict the choice of a device or client, are proprietary in nature, and further inhibit the network effect, wherein many individuals adopt or utilize a product or service, resulting in the product having its own popularity and/or momentum, irrespective of incremental features or functionality.

To address these issues with the generic, non-specific GSMA implementation procedures, at least two sets of embodiments are disclosed herein. A first set of embodiments is directed toward an enhanced capability management function, and a second set of embodiments is directed toward an enhanced capability management function plus a presence access layer. Each of these sets of embodiments will now be described in turn.

To reduce complexity, simplify interaction on behalf of RCS clients, and address the lack of scalability (i.e., the volume of messages exchanged as a device's RCS contact list grows) embodiments of the present disclosure provide an enhanced capability management function (ECMF). The term ‘enhanced’ may distinguish this capability management function from the generic RCS implementation procedures described in the GSMA specifications. This enhanced capability management function provides the interworking solutions outlined in the GSMA specifications as well as providing extended functionality not currently available in the existing interworking functions supported by the GSMA specifications.

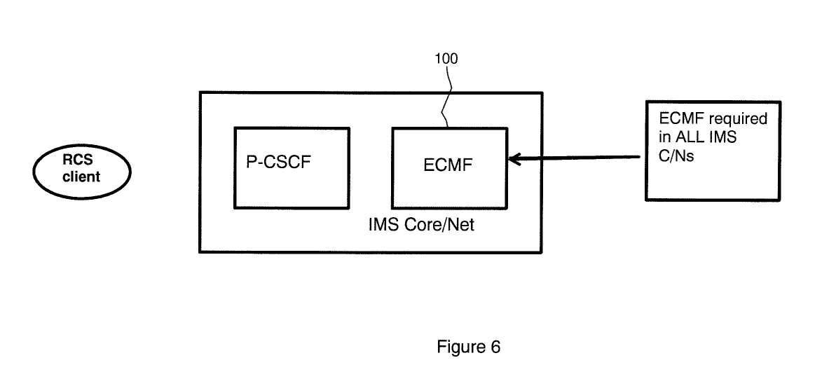

In an embodiment, the enhanced capability management function is an entity that may be located within an IMS core network to ensure that capability discovery and interworking capabilities exist and are available if required. FIG. 6 illustrates an embodiment of the enhanced capability management function, referred to in the figure as the ECMF 100. The ECMF 100 may also be referred to as the network node of the first type. In this embodiment, the enhanced capability management function 100 extends an ability of a first client (e.g., RCS client A) that supports a set of services to discover other clients (e.g., RCS clients B-Z) that support at least one service of the first client. At least one of the supported services may be an RCS capability discovery interworking function that has been extended to support all variants of service capability discovery described above. For example, the enhanced capability management function 100 may operate as a proxy on behalf of RCS client B and may receive and respond to P2P messages, such as SIP:OPTIONS requests, from RCS client A that are targeted for RCS client B. While an RCS client may continue to utilize and implement the existing RCS service capability discovery schemes described above, the enhanced capability management function 100 may permit an RCS client to reduce, in some cases dramatically, the number of messages exchanged and focus capability exchange into one specific area.

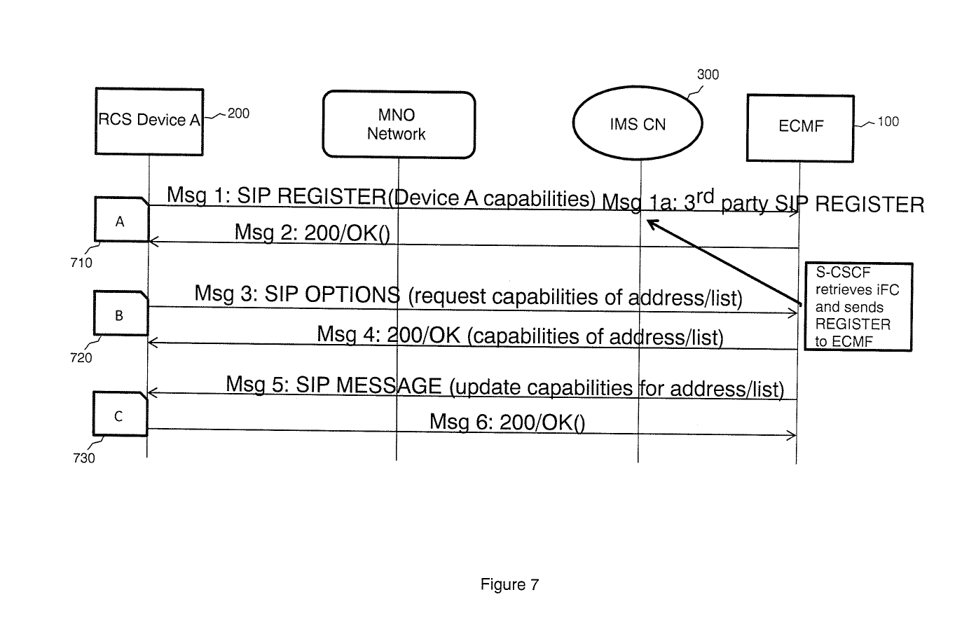

FIG. 7 illustrates how the enhanced capability management function 100 reduces complexity and supports the IMS core network based on three SIP message flows (Flows A, B, and C). In Flow A 710, the enhanced capability management function 100 is able to receive RCS service capabilities on behalf of an enhanced RCS client during a device's IMS registration request. That is, the enhanced capability management function 100 ‘piggy-backs’ Device A's RCS service capabilities in the register message payload. In Flow A 710, Flow B 720, and/or Flow C 730, the enhanced capability management function 100 is able to process a P2P-like request and deliver service capability information of one or more contacts and/or address lists. That is, the enhanced capability management function 100 may have the ability to receive a P2P request from an RCS device and provide a response as another RCS device, thereby acting as a proxy of sorts. In such a case, the IMS network may be assumed to have the capability to route P2P requests (e.g., destined for Device B) to the enhanced capability management function 100 instead and to route responses back to Device A as if they were originating from Device B. In Flow B 720 and/or Flow C 730, the enhanced capability management function 100 is able to synchronously or asynchronously (i.e., to one or more RCS clients) process and convey service capability information (e.g., based on network-related changes which impact RCS devices) of one or more contacts or an address list corresponding to an RCS device using an enhanced RCS client. Flow B 720 may support a synchronous call flow (message #3 and message #4) that provides the capabilities of a single address or a list of addresses or a list stored in the network. An example of network-related changes may be a third-party contact list or an address book synchronization that occurs in both directions between a network and a device's client and that may alter future endpoints (contacts, list of contacts, etc.) of service capability discovery on behalf of an RCS client. Information Flows A 710, B 720, and C 730 may be distinct sets of flows independent of one another or may be used in various combinations with one another.

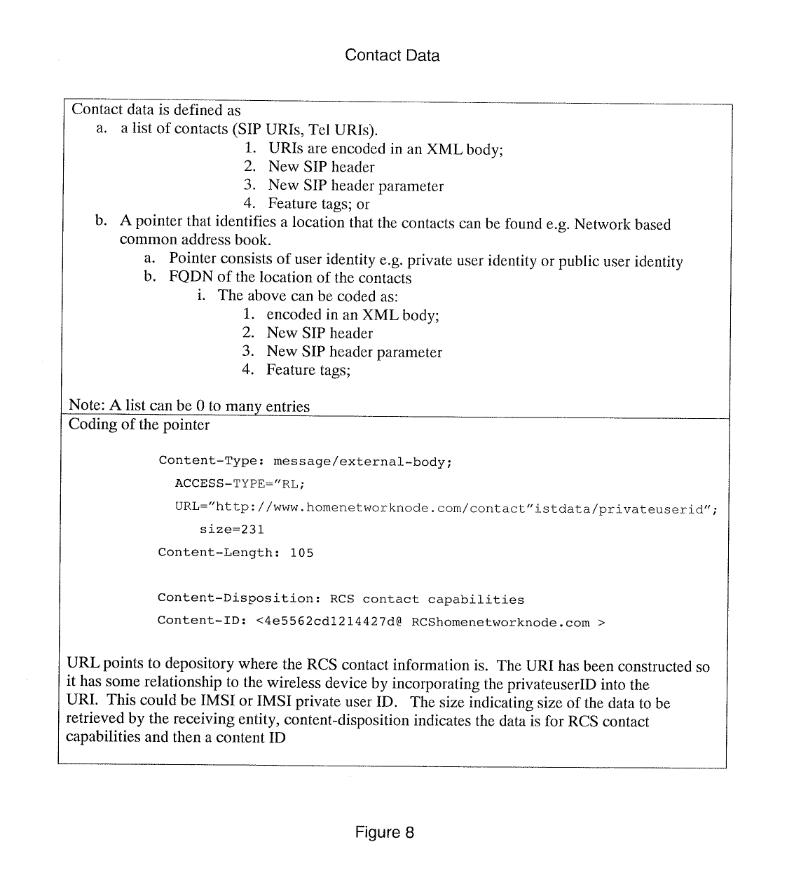

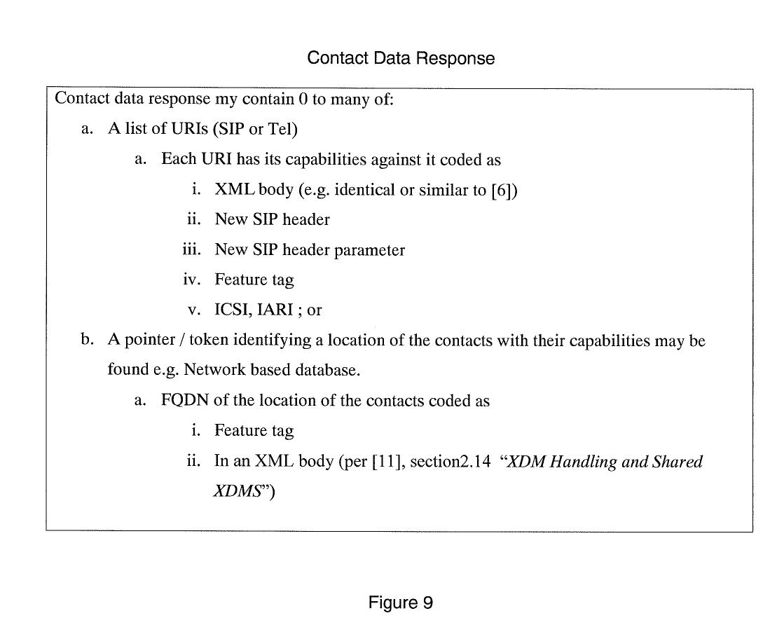

More specifically, in Flow A 710, a device A 200 that contains credentials A sends message #1 (e.g., SIP:REGISTER) to a network node in an IMS core network 300. The network node may be, but is not limited to, a proxy call session control function (P-CSCF), a serving CSCF (S-CSCF), or an application server. In an example, message #1 may contain the capabilities, e.g., RCS services, of device A and may identify the capabilities with a token or tag, such as an IMS communication service identifier (ICSI) or IMS application reference identifier (IARI) feature tag, etc. Such tags may correspond to equivalent RCS services. Message #1 may optionally contain contact data, as defined in FIG. 8. Responsive to receiving message #1, the network node may optionally perform a third-party registration by sending message #1a to a second network node. The second network node may be an application server, an interworking function, or both, or may be the enhanced capability management function 100. The second network node may also be a requestor. Message #1a may contain the contact data or service capabilities received in message #1. The network node may receive a SIP 200/OK message from the second network node. The network node may then send message #2, such as a SIP 200/OK, in response to message #1. The SIP 200/OK may optionally contain a contact data response, as defined in FIG. 9. The device 200 then receives message #2. Message #1a and message #2 may be asynchronous events that may occur at any time, but it should be understood that the SIP:REGISTER has to have a response. While the enhanced capability management function 100 may not receive message #1a, RCS Device A needs some type of response, such as a SIP 200/OK or some other type of message such as a failure/error message, e.g., a SIP 4xx error, etc. In an embodiment, the network node in the IMS core network 300 may be enhanced to include the behavior of the enhanced capability management function 100.

Flow B 720 may be invoked independently of Flow A 710 or as a continuation of the message dialogue corresponding to Flow A 710. In Flow B 720, if no data per the contact data response defined in FIG. 9 is received as part of Flow A 710 or as part of Flow B 720 invoked on its own, the device 200 sends message #3, such as a SIP:OPTIONS or a SIP:SUBSCRIBE, to the network node. The SIP:OPTIONS may include contact data defined in FIG. 8. With the SIP:SUBSCRIBE, Device A may subscribe to the contact data defined in FIG. 8 using the procedures described in Internet Engineering Task Force (IETF) Request for Comments (RFC) 3265, “Session Initiation Protocol (SIP)-Specific Event Notification”, June 2002, which is incorporated herein by reference. The SIP:SUBSCRIBE may utilize the ‘presence’ event package described in IETF RFC 3863, “Presence Information Data Format (PIDF)”, August 2004, which is incorporated herein by reference. The uniform resource identifier (URI) of the SIP:OPTIONS or the SIP:SUBSCRIBE may be created responsive to receiving a token in message #2 that was contained in the contact data defined in FIG. 8 or may be pre-provisioned in the device 200 (e.g., contact-list uri ‘rcs’). Pre-provisioned data may be information that is stored in a device either in the device's memory, such as an Open Mobile Alliance (OMA) Management Object (MO), or in a removable secure element, such as a universal integrated circuit card (UICC), universal subscriber identity module (USIM), IP multimedia services identity module (ISIM), or elsewhere. The enhanced capability management function 100 may receive message #3 and in response may send message #4, such as a SIP 200/OK. Message #4 may contain the contact data response defined in FIG. 9. Based on Flow B 720, Device A 200, which may contain an RCS client, may be able to update the service capabilities of an entire list of contacts with a single message exchange in the case where the 200/OK in message #4 includes the message payload.

Flow C 730 may be invoked independently of the message dialogues corresponding to Flow A 710 and/or Flow B 720 or as a continuation of the message dialogues of Flow A 710 and/or Flow B 720. In Flow C 730, if response message #4 from Flow B 720 or response message #2 from Flow A 710 did not contain the list of contacts and their capabilities as in the contact data response defined in FIG. 9, then the enhanced capability management function 100 may send message #5, such as a SIP:MESSAGE including at least one contact data response as outlined in FIG. 9, toward Device A 200. If Device A 200 issued message #3 as either a SIP:OPTIONS (P2P) or a SIP:SUBSCRIBE (SPI) toward the enhanced capability management function 100 with contact data as outlined in FIG. 8, then message #5 may contain the contact data response defined in FIG. 9. The device 200 receives message #5 and sends message #6, such as a SIP 200/OK in acknowledgement.

In Flow A 710, Flow B 720, or Flow C 730, the contact data response may be processed according to GSM Association, RCS_e_Specification_Document_{—}1_{—}2_{—}2: “RCS-e—Advanced Communications: Services and Client Specification—Version 1.2.2”, 4 Jul. 2012, section 2.3.1.1, “SIP OPTIONS message extension to support capability discovery”, which is incorporated herein by reference.

In an embodiment, the enhanced capability management function 100, upon receipt of message #1 or #3, may invoke the necessary functions to determine and capture the capabilities of the relevant communication peers of Device A 200. The enhanced capability management function 100 may also capture Device A's capabilities for use in responding to other device capability requests, such as RCS service capability requests. The enhanced capability management function 100 may operate as a requestor on behalf of Device A 200, which may permit the enhanced capability management function 100 to poll for or subscribe to the capabilities of contacts on behalf of Device A 200. Such polling or subscribing may include supporting a poll timer for throttling capability discovery with Device A's contact list. The message flows associated with such polling or subscribing may be similar to the flows outlined in the GSMA specifications but are not limited to the flows outlined in the GSMA specification cited above.

The enhanced capability management function 100 may also support a peer capabilities cache or data store. That is, the enhanced capability management function 100 may maintain a list of unique contacts and their associated capabilities independently of any terminal devices. In this manner, the enhanced capability management function 100 is able to provide, possibly in response to message #1 from Device A 200, capability information of any contact of Device A 200 without any additional network communication or processing. Device A's communication peers may be available directly to the enhanced capability management function 100, for example using a well-known contact or address list such as ‘rcs’. Alternatively, the peers may be specified as part of Device A's registration or through other means. For example, the peers may be specified by a stand-alone SIP:MESSAGE datagram in a manner similar to the message flows illustrated by Flow C 730, except originating from Device A 200.

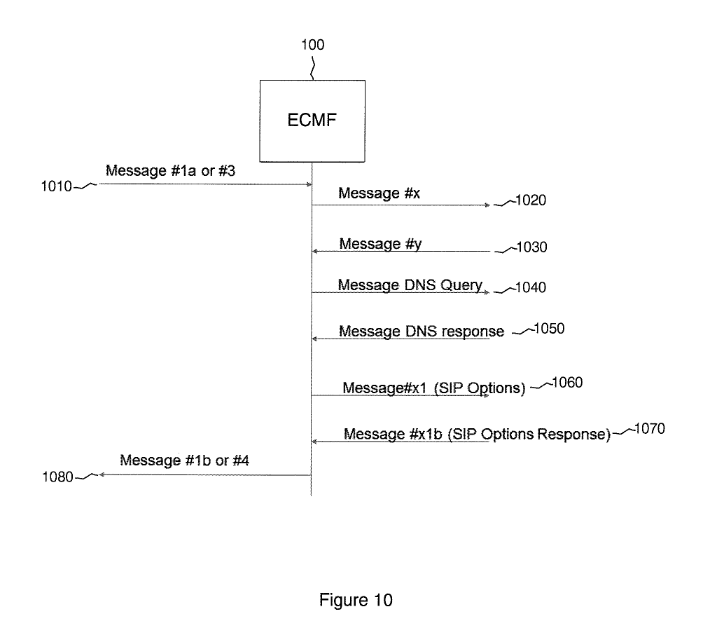

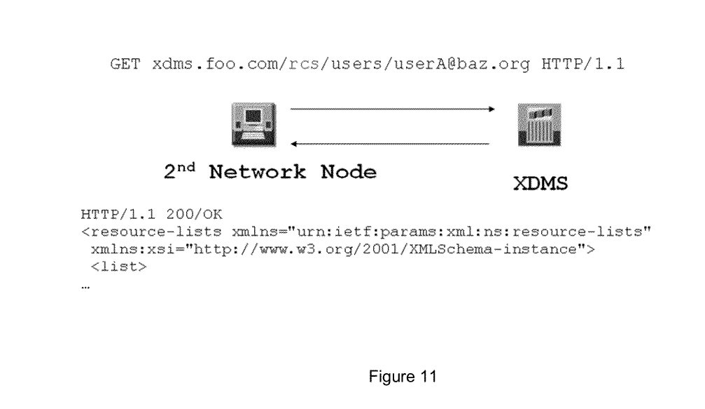

The behavior of the enhanced capability management function 100 in the flows of FIG. 7 is illustrated in FIG. 10. At event 1010, the enhanced capability management function 100 receives message #1a or message #3 of FIG. 7. If message #1a or message #3 contains contact data that contains data as defined in FIG. 8 then, at event 1020, the enhanced capability management function 100 sends message #x to an XDMS (XML (extensible markup language) document management server). Message #x may provide a list or a reference to a list, such as a resource list, of contact addresses of Device A, whose capabilities are to be established. The contact addresses may correspond to the contact data of FIG. 8. Message #x may be a hypertext transfer protocol (HTTP)/XML Configuration Access Protocol (XCAP) PUT/update. At event 1030, the enhanced capability management function 100 receives back message #y containing a contact data response as defined in FIG. 9. Message #y may be an HTTP 200/OK as illustrated in FIG. 11.

If message #1a or message #3 received by the enhanced capability management function 100 does not contain contact data, the enhanced capability management function 100, at event 1020, sends message #x, such as an HTTP GET/fetch, to an XDMS, as illustrated in FIG. 11. In this case, message #x may provide a list of ‘well-known’ (e.g., ‘rcs_basic_spi_only_grantedcontacts’) contact addresses of Device A, whose capabilities are to be established. At event 1030, the enhanced capability management function 100 receives back message #y, such as an HTTP 200/OK, containing a contact data response as defined in FIG. 9.

At event 1040, the enhanced capability management function 100 optionally sends a domain name system (DNS) query containing one or more URIs received in message #1a or message #3. At event 1050, a DNS response may be received back containing the URI and/or IP address indicating where other data may be obtained. At event 1060, the enhanced capability management function 100 sends a SIP:OPTIONS request to a URI that was received in message #1a contact data, in message #3 contact data, or in the DNS response of event 1050. A number of SIP:OPTIONS may be sent, depending on the number of URIs that were received in message #1a or message #3 or in the DNS response of event 1050. At event 1070, the enhanced capability management function 100 receives back one or more SIP:OPTIONS responses containing one or more SIP/TEL URIs containing RCS capability information against those URIs.

FIG. 11 illustrates how the enhanced capability management function 100 may retrieve or otherwise fetch a contact list of an RCS client or device. In this case, the URI is constructed using a well-known name (‘rcs’) on behalf of Device A, from the associated XDMS (i.e., xdms.foo.com).

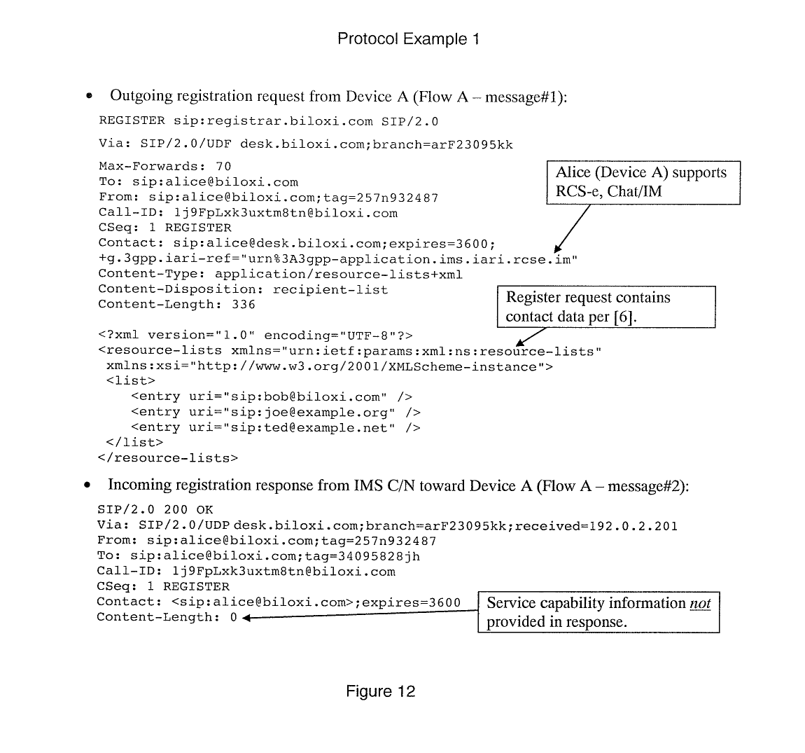

An example IMS registration Flow A 710 which conveys Device A's capabilities and includes contact data is illustrated in Protocol Example 1 in FIG. 12. In this example, Device A specifies communication peers with which to determine capabilities. The outgoing registration message from Device A omits the Accept header, which indicates to the enhanced capability management function 100 to convey the capabilities of Device A's contacts in a separate message to Device A. The message flow is illustrated in FIG. 7, Flow C 730.

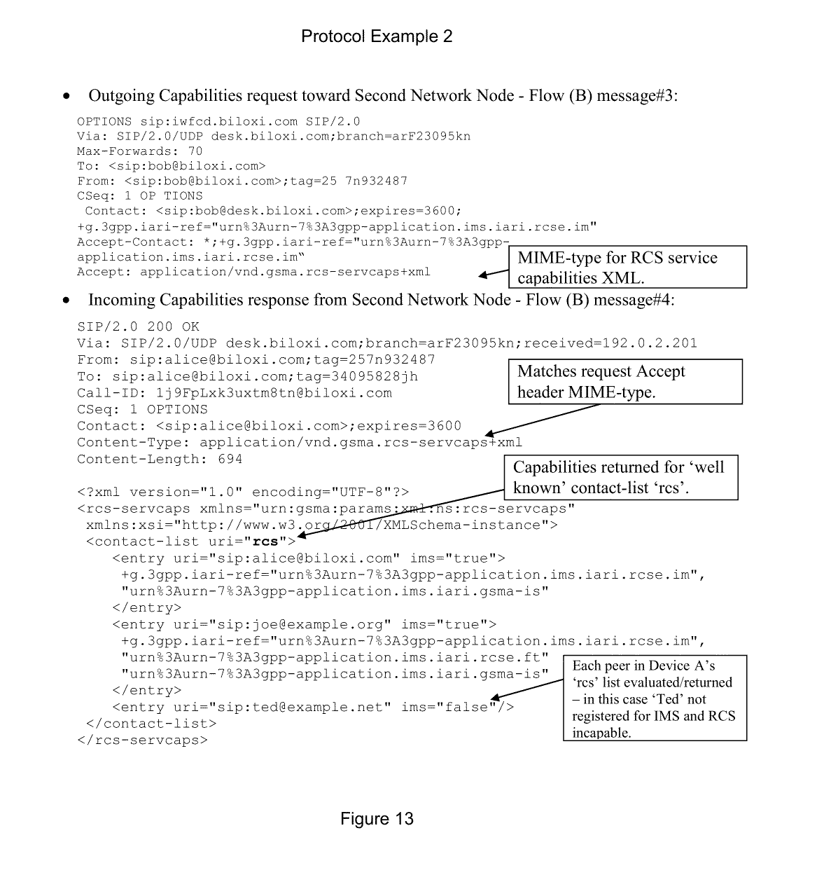

An example of Device A's enhanced RCS client issuing a P2P-like service capability discovery request to the enhanced capability management function 100, as in Flow B 720, is illustrated in Protocol Example 2 in FIG. 13. In this example, Device A directs a P2P capabilities request to the enhanced capability management function 100 within the network. As with a typical RCS P2P exchange, Device A's RCS client conveys its own service capabilities. This example illustrates the flow shown in FIG. 11, where Device A omits contact data, thus indicating to the enhanced capability management function 100 to utilize a well-known contact list. In some embodiments, the well-known contact list may rely on a fixed name, such as ‘rcs’. In other embodiments, the well-known name may be provisioned, for example within a relevant management object, towards the enhanced capability management function 100.

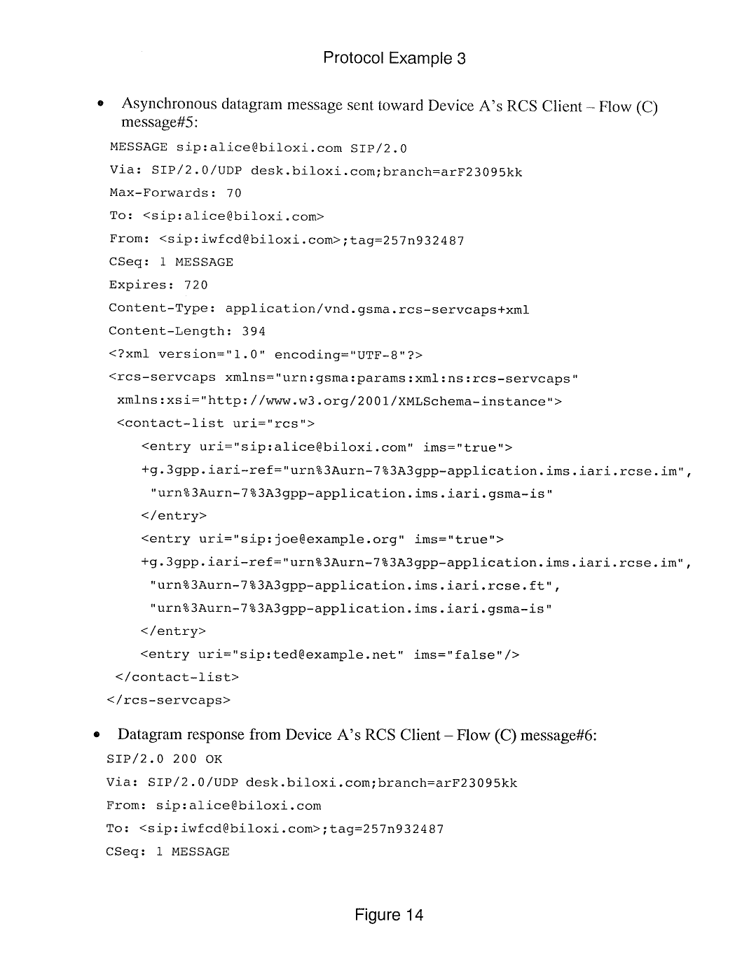

An example of an RCS client receiving a message from the enhanced capability management function 100 updating the capabilities of Device A's contacts, as in Flow C 730, is illustrated in Protocol Example 3 in FIG. 14. Example messages in both Flow B 720 and Flow C 730 assume that Device A's RCS client has successfully registered and authenticated with the IMS core network. Further authentication may be required between the enhanced capability management function 100 and Device A's RCS client and is assumed to have occurred in the examples shown in FIGS. 12, 13, and 14.

Calculations were provided above demonstrating the number of messages that may be transmitted in the current RCS service capability discovery procedure. Similar calculations performed for the capability discovery procedures disclosed herein demonstrate that the disclosed procedures may decrease, and in some instances may significantly decrease, the number of messages. For example, on a first-time RCS client start, Device A utilizes two messages in the best case: one SIP:REGISTER and one response. If network policy dictates that the enhanced capability management function 100 is unable to overload a SIP 200/OK response, that is, if the SIP 200/OK response is unable to incorporate a message payload, Device A utilizes four messages: one SIP:REGISTER, one SIP:OPTIONS (Flow B 720) or one SIP:MESSAGE (Flow C 730), and two responses. For 100 individual RCS devices in a network, 200 message exchanges occur in the best case, and 400 messages exchanges occur when SIP 200/OK is limited on the network. For 10,000 RCS devices, the number of message exchanges grows to a very manageable 20,000 message exchanges in the best case and 40,000 messages when SIP 200/OK is limited on the network in terms of incorporating a message payload. Thus, the enhanced capability management function 100 operating within the IMS core network may address scalability issues, such as an increasing number of RCS devices within the network.

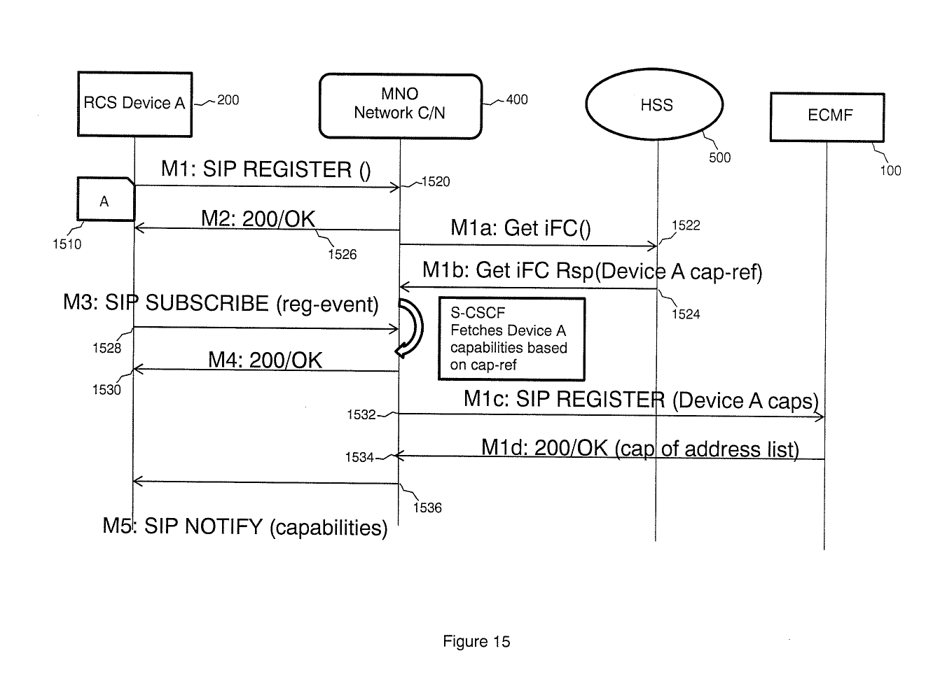

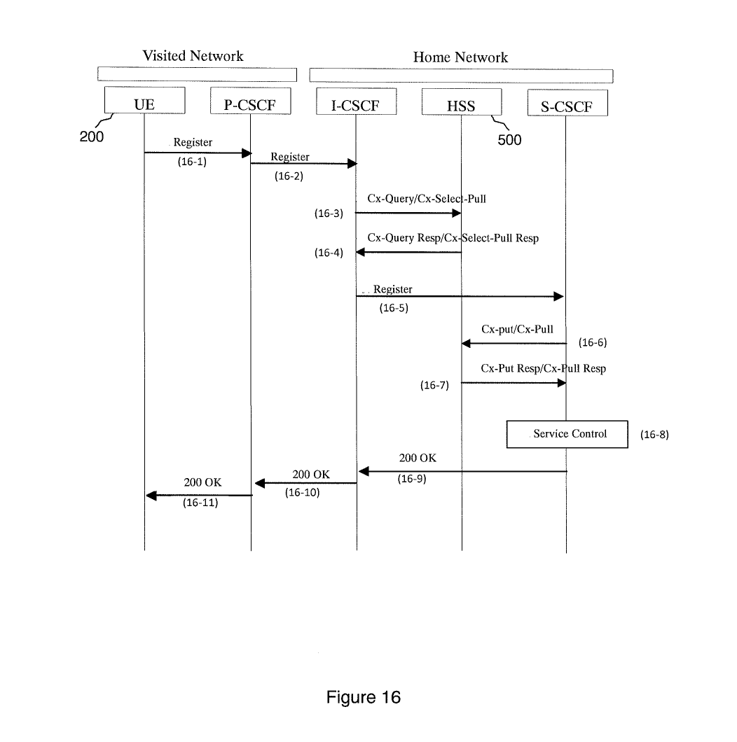

In some cases, the network policy of the MNO's IMS core network may not permit message #1 of Flow A 710 to proceed to a third party, as illustrated in message #1a of Flow A 710. FIGS. 15 and 16 illustrate embodiments of an alternative to Flow A 710 that may address such situations. In addition to the enhanced capability management function 100, the embodiments utilize another network node, such as a database function that may be but is not limited to a Home Subscriber Server (HSS) or a Home Location Register (HLR). This network node may be referred to hereinafter as an HSS, but it should be understood that this network node may be some other type of component that can perform similar functions.

In Flow A 1510 of FIG. 15, at event 1520, Device A 200 sends message #1, such as a SIP:REGISTER message, to a network node, such as an S-CSCF, in an MNO core network 400. Message #1 contains the service capabilities, such as the RCS capabilities, of Device A 200, which may be coded as information tags such as +g.3gpp.cs-voice. Message #1 of FIG. 15 may be equivalent to Message 16-5 of FIG. 16. After receiving message #1, the network node sends message 16-6 of FIG. 16 to another network node, such as an HSS 500, and may receive back message 16-7 from the HSS 500. Message 16-7 may contain an optional information element, such as the tServiceinfo information element defined in Third Generation Partnership Project (3GPP) Technical Specification (TS) 29.228, “IP Multimedia (IM) Subsystem Cx and Dx Interfaces; Signalling flows and message contents”, version 11.7.0, Mar. 13, 2013, which is incorporated herein by reference. This information element may contain device capabilities, such as RCS device capabilities, and/or contact data as defined in FIG. 8.

If contact data contains data defined in section (b) of FIG. 8, that is, if contact data contains a pointer to a location of contact information, then the network node sends message #x 1020 and receives message #y 1030 as described in FIG. 10. If contact data contains data defined in section (a) of FIG. 8, that is, if contact data contains a list of contacts, or if contact data that contains data defined in section (b) of FIG. 8 was received, then the network node, at event 1522, sends message #1a, such as a GetiFC message, to the HSS 500. The network node then, at event 1524, receives message #1b, such as a Get iFC Rsp message, from the HSS 500. Message #1b may also include Device A's capabilities or a reference to Device A's capabilities. The network node may utilize Device A's capabilities to fetch contact data as defined in FIG. 8. The network node, after detecting Device A's third-party registration with the enhanced capability management function 100, via messages #1c at event 1532 and #1d at event 1534, transmits asynchronous message #5, such as a SIP:NOTIFY message, at event 1536. Message #5 may be based on ‘reg-event’ event package subscription and may contain a contact data response as defined in FIG. 9. The network node, at event 1526, sends message #2, such as a SIP 200/OK message, to Device A 200 in response to synchronous message #1. Event 1526 may take place within any reasonable amount of time after event 1520. However, the initial registration is synchronous and therefore must be responded to, as shown by event 1526.

At event 1528, Device A 200, which may contain an enhanced RCS client, sends message #3, such as a SIP:SUBSCRIBE message, to the network node with the reg-event package. At event 1530, Device A 200 receives message #4, such as a SIP 200/OK message, in response to message #3.

In summary, the flow of FIGS. 15 and 16 may be described as follows: A SIP:REGISTER conveys to the MNO's IMS core network a registration request. An immediate (empty) 200/OK is returned from the core network. The core network issues a Get iFC towards the HSS in the core network, and the HSS replies with either Device A's capabilities or a reference to Device A's capabilities. The S-CSCF fetches the service capabilities of Device A based on a Get iFC Rsp( )message 1524. Device A, which may contain the enhanced RCS client, issues a Subscribe for the reg-event package and receives a positive acknowledgement (200/OK). The core network issues a Notify, such as the message #5 SIP:NOTIFY 1536, to Device A with the capabilities, e.g., RCS capabilities, of Device A's RCS contacts resolved by the enhanced capability management function 100 (1532/1534).

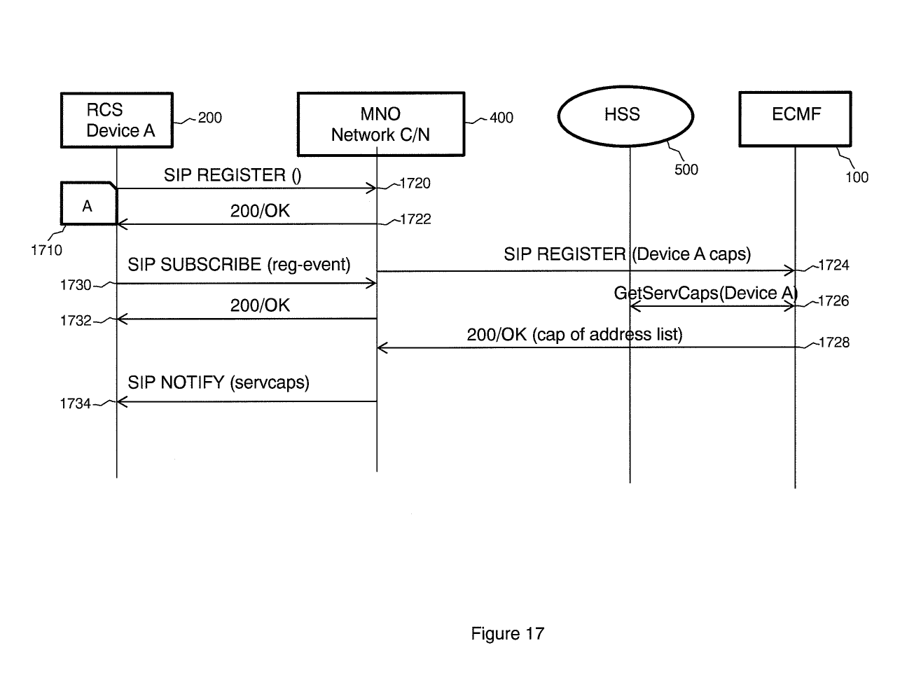

In other embodiments, an alternative to Flow A 1510 is possible that utilizes the enhanced capability management function 100 on its own. FIG. 17 illustrates this alternative Flow A 1710. At event 1720, a SIP:REGISTER from Device A 200 conveys to the MNO's core network 400 a registration request. At event 1722, an immediate (empty) 200/OK is returned from the core network 400. This 200/OK may be similar to the message shown at event 1526 in FIG. 15. At event 1724, the core network 400 issues a third-party SIP:REGISTER towards the enhanced capability management function 100. At event 1726, the enhanced capability management function 100 requests and receives Device A's service capabilities. The request may be made to the HSS 500 using ‘GetServCaps( )’ or to other elements within the IMS core network (e.g., an application service such as a third-party address book or a device capabilities database). At event 1728 the enhanced capability management function 100 establishes and replies to the core network 400 with a 200/OK that includes Device A's service capabilities. Substantially simultaneously with the third-party registration procedure, at event 1730, Device A 200 issues a Subscribe for the reg-event pkg. At event 1732, Device A 200 receives a positive acknowledgement (200/OK). Later, at event 1734, the core network 400 issues a Notify, such as a SIP:NOTIFY, to Device A 200 with the service capabilities of Device A's RCS contacts that were received as a result of the third-party registration.

In another embodiment, alternatives to Flow A 1510 in FIG. 15 and Flow A 1710 in FIG. 17 may be handled via the IMS Ut interface. An appropriate HTTP/1.1 protocol interaction may be included by using, for example, the HTTP/1.1 PUT or POST in lieu of a SIP:REGISTER. This embodiment may, for example, support a Web Service (SOAP) or a RESTful type interface on behalf of an enhanced RCS client, so equipped.

If there are issues of message size (e.g., in terms of the size of a datagram for SIP over the user datagram protocol) then the example flows shown in FIGS. 11 and 15 demonstrate methods which utilize indirect content stores to mitigate such issues. Such an indirect content store may be, for example, an XDMS application-usage for containing Device A's contact list and/or contact list service capabilities cache. That is, URL or URI references may be exchanged as part of SIP messages to fulfill datagram size limits. In another embodiment, the indirect content store could be a non-standard third-party contact list and/or service capabilities capture service (e.g., an enhanced Plaxo or Google™ contacts application service). In another embodiment, a contact list or a similar data store may be accessed through a RESTful type interface.

A second set of embodiments provides additional capabilities that may be incorporated into the enhanced capability management function 100 to reduce RCS client complexity and to reconcile with the RCS client events which may occur asynchronously in a service provider's network. More specifically, in these embodiments, presence access layer (PAL) functionality is added to the enhanced capability management function 100. The introduction of an OMA PAL server (as described in OMA-TS-PAL-V1_{—}0-20120320-A: “Presence Access Layer Specification”, Apr. 25, 2012, which is incorporated herein by reference) in connection with an IMS core network may allow a network to efficiently make use of SPI or P2P augmented with SPI in support of RCS service capability discovery.

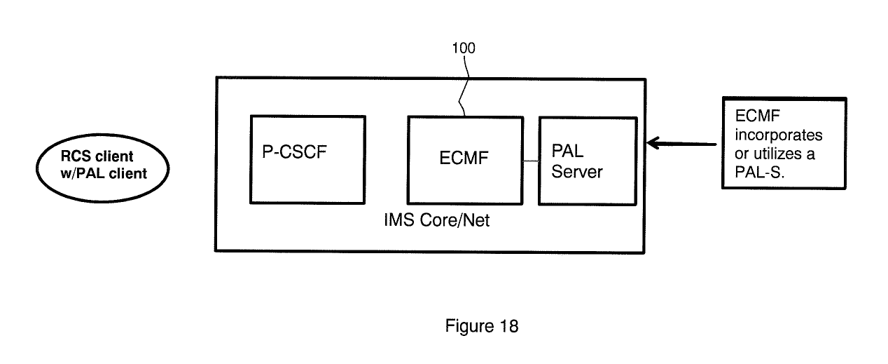

These embodiments may further reduce RCS client processing overhead and complexity and permit RCS clients to offload all or part of a watcher-agent function required to support SPI or augmented P2P/SPI capability discovery. That is, in these embodiments, such functions are migrated to an enhanced capability management function 100 that provides PAL-like capabilities. The enhanced capability management function 100 collects indications provided by network elements or data sources accessible throughout the IMS core network. These indications may be exposed and accessed through one or more PAL aspects from a PAL presence context. For example, a PAL may receive such information from a core network element, such as an IMS Registrar. Alternatively, these indications may be calculated or derived through a mixture of PAL presence aspects and other indicia retrieved and processed by the enhanced capability management function 100. The use of such indications allows an appropriate point in time to be determined at which to notify affected RCS clients. An alternative enhanced capability management function 100 which utilizes a PAL server is illustrated in FIG. 18.

In an embodiment, PAL server capabilities are incorporated into the enhanced capability management function 100, thus exposing a PAL-1i interface toward one or more enhanced RCS/PAL clients. In another embodiment, the enhanced capability management function 100 may work in conjunction with a PAL server, such as a PAL server co-located with or accessible from the same IMS core network as the enhanced capability management function 100. In either case, the enhanced capability management function 100 may also assume the role of a PAL client, and thus a requesting client, such as an RCS client, need not support a PAL interface.

The inclusion of PAL capabilities in the enhanced capability management function 100 enables an IMS core network to derive and reconcile capability discovery information applicable to an RCS client. The enhanced capability management function 100 supports at least two RCS processing scenarios.

In a first scenario, a service provider, such as a mobile network operator, un-registers or de-provisions a network subscriber as an RCS user. For example, the user may change their rate plans to a lower cost option which excludes support for RCS services. That is, a subscriber's optIn aspect value for an RCS service may change from true to false. In this scenario, either the enhanced capability management function 100 or the enhanced RCS client may be notified via the PAL-1i interface that a change has occurred in the network in relation to communication peers. The notification may occur through an action associated with a PAL trigger. Such a procedure may relieve the RCS client from having to support a subset of run conditions and may dramatically simplify the RCS client in terms of processing scenarios and complexity. Such a procedure may also help close another identified gap in RCS, namely a situation where a mobile operator provisions a device with ‘enableRCSeSwitch’ set to false/‘0’. This switch controls the visibility of the master RCS-e traffic switch. If a user turns this switch off near the time an auto-config update is received, it may be difficult to turn the switch back on again. This notification may enable the client to know from the mobile operator that the RCS user is RCS capable, and therefore the client may take corrective action, e.g., enabling the switch to be visible once again, albeit in the ‘turned off’ state (i.e., disable RCS traffic).

In a second scenario, an IMS core network may be able to determine that one or more devices are indirect communication peers, but one or more of the devices may not realize that this connection exists. As an example of indirect communication peers, both Device B and Device C may, unbeknownst to each other, have communication peer Device A as a common contact. The IMS core network may make such a determination based on indications available to network elements and/or data sources accessible to the IMS core network. In an embodiment, the enhanced capability management function 100 may suggest new or additional communication partners based on existing relationships. For example, the aspect suggestedPeers may be triggered toward RCS client Alice to notify her of users she may wish to add to her RCS contact list.

In the second scenario, the enhanced capability management function 100 may utilize the PAL as an information proxy and may establish an appropriate PAL presence context with PAL presence aspects or triggers. The resulting PAL presence context may be focused on directly or indirectly exposing an RCS service-capable view of information sources detected through many different means. This may include suggested communication peers for a target device based on PAL rules and/or policy and also taking into account the associated RCS service capabilities of each ‘eligible’ communication peer. Such suggestions may come about as a result of an initial IMS registration as described above. Such suggestions may also come about through presence indications captured and processed via PAL rules and/or policy by the PAL server. Alternatively, such indications may come through the ‘suggested contacts’ feature of OMA CAB 1.1, as described in OMA-TS-CAB-V1_{—}1-20120904-C: “Converged Address Book (CAB) Specification”, Sep. 24, 2012, which is incorporated herein by reference. Such indications may be directly processed by the enhanced capability management function 100.

The issue of notifying devices of the resolution of conflicting or erroneous information may relate to data that in some cases may impact a device's capability for RCS or the RCS services relevant to a given device. For example, the IMS core network may detect service capabilities based on indications or states not normally available to RCS clients. For instance, as part of IMS registration, the registrar or the IMS core network may subscribe to the ‘reg-event’ package for a given device, as described in IETF RFC 3680, “A Session Initiation Protocol (SIP) Event Package for Registrations”, March 2004, which is incorporated herein by reference. If the same device is subsequently detected as ‘out of coverage’ or de-registers, a notification is sent to the device for ‘reg-event’ within the IMS core network. As a result, the detection of such a notification by the enhanced capability management function 100 may be used to determine that an ‘out of coverage user’ is no longer registered to the IMS core network and is therefore ‘RCS incapable over any RCS service’. After a given threshold time period has elapsed, the enhanced capability management function 100 may notify or update relevant communication peers that the device's RCS client is no longer able to communicate with the network. This notification may be transmitted to the affected RCS clients through an asynchronous notification using, for example, a SIP:MESSAGE as illustrated in Flow C 730 of FIG. 7.

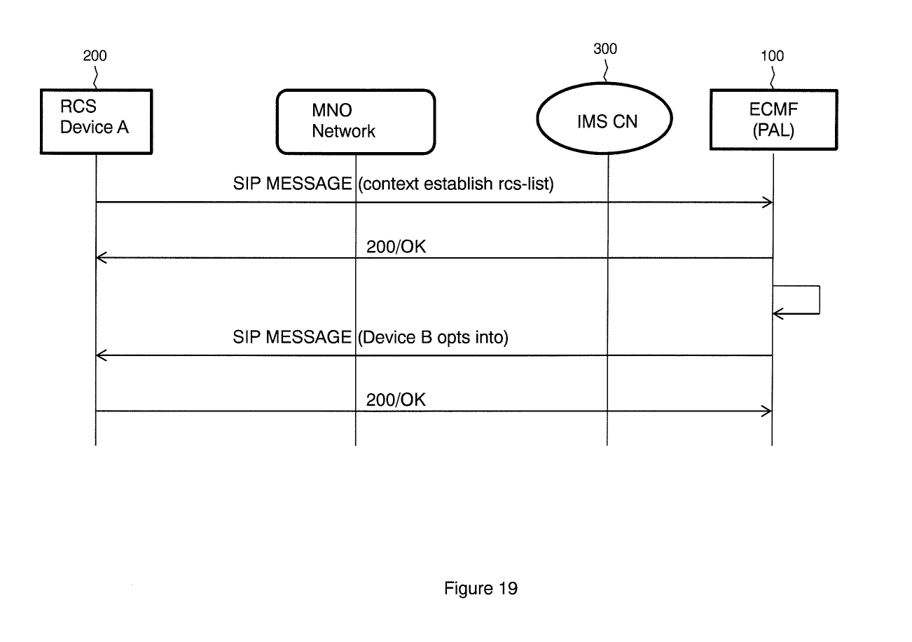

FIG. 19 illustrates how the enhanced capability management function 100 with a PAL incorporated supports an RCS client by monitoring SPI information on behalf of one or more of Device A's contacts. As shown in FIG. 19, an RCS client associated with Device A 200 and also incorporating PAL client functionality operates as part of a network of a service provider or MNO. Within the network is an enhanced capability management function 100 that includes a PAL service entity.

Device A's RCS client may communicate with the enhanced capability management function 100 either directly or indirectly to establish a PAL presence context. This context may be focused on RCS and the conveyance of service capabilities corresponding to the RCS service suite. For example, a determination may be made regarding whether a communication partner of Device A 200 (e.g., Device B's RCS client, ‘Bob’) has become able or has ‘opted in’ to an RCS service. As a result, a presence context may be successfully established, which may be indicated by a SIP 200/OK response that includes a PAL presence context identifier. At some point later in the flow, the enhanced capability management function 100 may detect that Device B's RCS client, ‘Bob’, has now ‘opted in’ to receive a given RCS service such as group chat. This may cause an associated PAL trigger to execute. That is, on Device B ‘optIn’ to RCS-e/group chat, the trigger action may be to initiate an asynchronous notification to Device A 200. Thus, Device A's RCS/PAL client may receive a message, such as a SIP:MESSAGE, containing the updated optIn to RCS group chat information. See, for example, the OMA Presence Access Layer, Data Definition Specification (Open Mobile Alliance specification “Presence Access Layer Data Specification”, Nov. 1, 2011, OMA-DDS-PAL_Data_Ext-V1_{—}1-20111101-A, which is incorporated herein by reference). This specification includes FQDN, rules/policy and presence aspect ‘optIn’. Device A's client may be able to update capability information from the PAL message without any associated RC complexities. “RC complexities” refers to the logic complexity of maintaining and supporting the run conditions (RC) on the client device/terminal. Such a procedure may demonstrate how asynchronous actions in the network may be able to occur without any direct involvement by the RCS device or client.

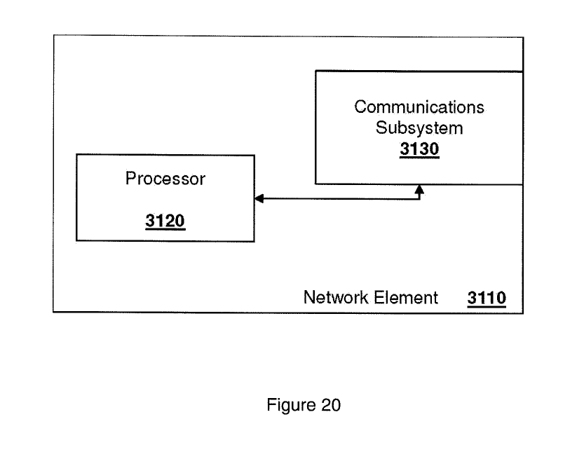

The concepts described above may be implemented by a network element. A simplified network element is shown with regard to FIG. 20. In FIG. 20, network element 3110 includes a processor 3120 and a communications subsystem 3130, where the processor 3120 and communications subsystem 3130 cooperate to perform the methods described above.

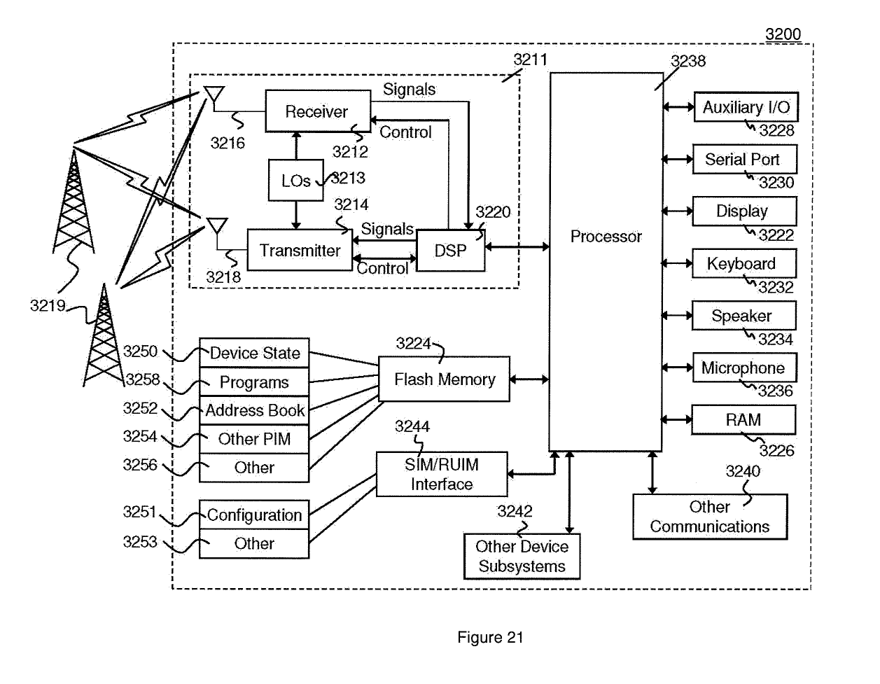

Further, the above may be implemented by a UE. One exemplary device is described below with regard to FIG. 21. UE 3200 is typically a two-way wireless communication device having voice and data communication capabilities. UE 3200 generally has the capability to communicate with other computer systems on the Internet or other networks. Depending on the exact functionality provided, the UE may be referred to as a data messaging device, a two-way pager, a wireless e-mail device, a cellular telephone with data messaging capabilities, a wireless Internet appliance, a wireless device, a mobile device, or a data communication device, as examples.

Where UE 3200 is enabled for two-way communication, it may incorporate a communication subsystem 3211, including a receiver 3212 and a transmitter 3214, as well as associated components such as one or more antenna elements 3216 and 3218, local oscillators (LOs) 3213, and a processing module such as a digital signal processor (DSP) 3220. As will be apparent to those skilled in the field of communications, the particular design of the communication subsystem 3211 will be dependent upon the communication network in which the device is intended to operate.

Network access requirements will also vary depending upon the type of network 3219. In some networks network access is associated with a subscriber or user of UE 3200. A UE may require a removable user identity module (RUIM) or a subscriber identity module (SIM) card in order to operate on a network. The SIM/RUIM interface 3244 is normally similar to a card-slot into which a SIM/RUIM card can be inserted and ejected. The SIM/RUIM card can have memory and hold many key configurations 3251, and other information 3253 such as identification, and subscriber related information.

When required network registration or activation procedures have been completed, UE 3200 may send and receive communication signals over the network 3219. As illustrated, network 3219 can consist of multiple base stations communicating with the UE.

Signals received by antenna 3216 through communication network 3219 are input to receiver 3212, which may perform such common receiver functions as signal amplification, frequency down conversion, filtering, channel selection and the like. Analog to digital (A/D) conversion of a received signal allows more complex communication functions such as demodulation and decoding to be performed in the DSP 3220. In a similar manner, signals to be transmitted are processed, including modulation and encoding for example, by DSP 3220 and input to transmitter 3214 for digital to analog (D/A) conversion, frequency up conversion, filtering, amplification and transmission over the communication network 3219 via antenna 3218. DSP 3220 not only processes communication signals, but also provides for receiver and transmitter control. For example, the gains applied to communication signals in receiver 3212 and transmitter 3214 may be adaptively controlled through automatic gain control algorithms implemented in DSP 3220.

UE 3200 generally includes a processor 3238 which controls the overall operation of the device. Communication functions, including data and voice communications, are performed through communication subsystem 3211. Processor 3238 also interacts with further device subsystems such as the display 3222, flash memory 3224, random access memory (RAM) 3226, auxiliary input/output (I/O) subsystems 3228, serial port 3230, one or more keyboards or keypads 3232, speaker 3234, microphone 3236, other communication subsystem 3240 such as a short-range communications subsystem and any other device subsystems generally designated as 3242. Serial port 3230 can include a USB port or other port known to those in the art.

Some of the subsystems shown in the figure perform communication-related functions, whereas other subsystems may provide “resident” or on-device functions. Notably, some subsystems, such as keyboard 3232 and display 3222, for example, may be used for both communication-related functions, such as entering a text message for transmission over a communication network, and device-resident functions such as a calculator or task list.

Operating system software used by the processor 3238 may be stored in a persistent store such as flash memory 3224, which may instead be a read-only memory (ROM) or similar storage element (not shown). Those skilled in the art will appreciate that the operating system, specific device applications, or parts thereof, may be temporarily loaded into a volatile memory such as RAM 3226. Received communication signals may also be stored in RAM 3226.

As shown, flash memory 3224 can be segregated into different areas for both computer programs 3258 and program data storage 3250, 3252, 3254 and 3256. These different storage types indicate that each program can allocate a portion of flash memory 3224 for their own data storage requirements. Processor 3238, in addition to its operating system functions, may enable execution of software applications on the UE. A predetermined set of applications that control basic operations, including at least data and voice communication applications for example, will normally be installed on UE 3200 during manufacturing. Other applications could be installed subsequently or dynamically.

Applications and software may be stored on any computer readable storage medium. The computer readable storage medium may be a tangible or in transitory/non-transitory medium such as optical (e.g., CD, DVD, etc.), magnetic (e.g., tape) or other memory known in the art.

One software application may be a personal information manager (PIM) application having the ability to organize and manage data items relating to the user of the UE such as, but not limited to, e-mail, calendar events, voice mails, appointments, and task items. Naturally, one or more memory stores may be available on the UE to facilitate storage of PIM data items. Such PIM application may have the ability to send and receive data items, via the wireless network 3219. Further applications may also be loaded onto the UE 3200 through the network 3219, an auxiliary I/O subsystem 3228, serial port 3230, short-range communications subsystem 3240 or any other suitable subsystem 3242, and installed by a user in the RAM 3226 or a non-volatile store (not shown) for execution by the processor 3238. Such flexibility in application installation increases the functionality of the device and may provide enhanced on-device functions, communication-related functions, or both. For example, secure communication applications may enable electronic commerce functions and other such financial transactions to be performed using the UE 3200.

In a data communication mode, a received signal such as a text message or web page download will be processed by the communication subsystem 3211 and input to the processor 3238, which may further process the received signal for output to the display 3222, or alternatively to an auxiliary I/O device 3228.

A user of UE 3200 may also compose data items such as email messages for example, using the keyboard 3232, which may be a complete alphanumeric keyboard or telephone-type keypad, among others, in conjunction with the display 3222 and possibly an auxiliary I/O device 3228. Such composed items may then be transmitted over a communication network through the communication subsystem 3211.

For voice communications, overall operation of UE 3200 is similar, except that received signals may typically be output to a speaker 3234 and signals for transmission may be generated by a microphone 3236. Alternative voice or audio I/O subsystems, such as a voice message recording subsystem, may also be implemented on UE 3200. Although voice or audio signal output is preferably accomplished primarily through the speaker 3234, display 3222 may also be used to provide an indication of the identity of a calling party, the duration of a voice call, or other voice call related information for example.

Serial port 3230 may normally be implemented in a personal digital assistant (PDA)-type UE for which synchronization with a user's desktop computer (not shown) may be desirable, but is an optional device component. Such a port 3230 may enable a user to set preferences through an external device or software application and may extend the capabilities of UE 3200 by providing for information or software downloads to UE 3200 other than through a wireless communication network. The alternate download path may for example be used to load an encryption key onto the device through a direct and thus reliable and trusted connection to thereby enable secure device communication. As will be appreciated by those skilled in the art, serial port 3230 can further be used to connect the UE to a computer to act as a modem.

Other communications subsystems 3240, such as a short-range communications subsystem, is a further optional component which may provide for communication between UE 3200 and different systems or devices, which need not necessarily be similar devices. For example, the subsystem 3240 may include an infrared device and associated circuits and components or a Bluetooth™ communication module to provide for communication with similarly enabled systems and devices. Subsystem 3240 may further include non-cellular communications such as WiFi or WiMAX.

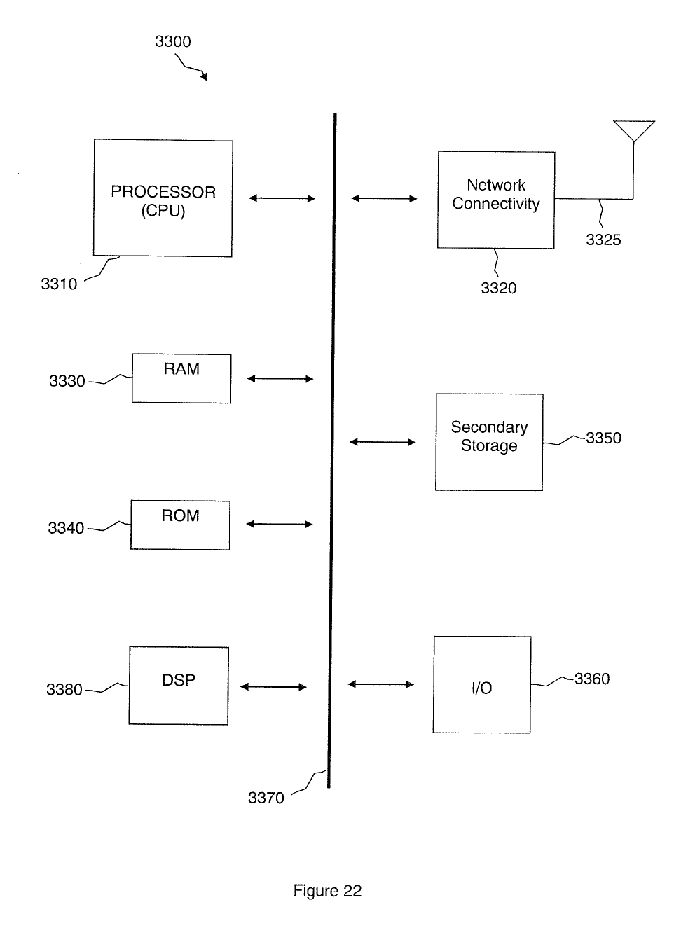

The UE and other components described above might include a processing component that is capable of executing instructions related to the actions described above. FIG. 22 illustrates an example of a system 3300 that includes a processing component 3310 suitable for implementing one or more embodiments disclosed herein. The processing component 3310 may be substantially similar to the processor 3120 of FIG. 20 and/or the processor 3238 of FIG. 21.

In addition to the processor 3310 (which may be referred to as a central processor unit or CPU), the system 3300 might include network connectivity devices 3320, random access memory (RAM) 3330, read only memory (ROM) 3340, secondary storage 3350, and input/output (I/O) devices 3360. These components might communicate with one another via a bus 3370. In some cases, some of these components may not be present or may be combined in various combinations with one another or with other components not shown. These components might be located in a single physical entity or in more than one physical entity. Any actions described herein as being taken by the processor 3310 might be taken by the processor 3310 alone or by the processor 3310 in conjunction with one or more components shown or not shown in the drawing, such as a digital signal processor (DSP) 3380. Although the DSP 3380 is shown as a separate component, the DSP 3380 might be incorporated into the processor 3310.

The processor 3310 executes instructions, codes, computer programs, or scripts that it might access from the network connectivity devices 3320, RAM 3330, ROM 3340, or secondary storage 3350 (which might include various disk-based systems such as hard disk, floppy disk, or optical disk). While only one CPU 3310 is shown, multiple processors may be present. Thus, while instructions may be discussed as being executed by a processor, the instructions may be executed simultaneously, serially, or otherwise by one or multiple processors. The processor 3310 may be implemented as one or more CPU chips.

The network connectivity devices 3320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 3320 may enable the processor 3310 to communicate with the Internet or one or more telecommunications networks or other networks from which the processor 3310 might receive information or to which the processor 3310 might output information. The network connectivity devices 3320 might also include one or more transceiver components 3325 capable of transmitting and/or receiving data wirelessly.

The RAM 3330 might be used to store volatile data and perhaps to store instructions that are executed by the processor 3310. The ROM 3340 is a non-volatile memory device that typically has a smaller memory capacity than the memory capacity of the secondary storage 3350. ROM 3340 might be used to store instructions and perhaps data that are read during execution of the instructions. Access to both RAM 3330 and ROM 3340 is typically faster than to secondary storage 3350. The secondary storage 3350 is typically comprised of one or more disk drives or tape drives and might be used for non-volatile storage of data or as an over-flow data storage device if RAM 3330 is not large enough to hold all working data. Secondary storage 3350 may be used to store programs that are loaded into RAM 3330 when such programs are selected for execution.

The I/O devices 3360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 3325 might be considered to be a component of the I/O devices 3360 instead of or in addition to being a component of the network connectivity devices 3320.

In an embodiment, a method for communicating service capability information is provided. The method comprises receiving, by a network entity, a message that indicates that a sender of the message is an RCS client, wherein the message includes a list of the sender's client capabilities and a list of contacts about whom the sender wishes to receive presence-related information; establishing, by the network entity, a presence context based on the sender being an RCS client and the list of client capabilities and contacts of the sender; using, by the network entity, the presence context to monitor events in a network; and conveying, by the network entity, information regarding the monitored events to at least one device in the network.

In another embodiment, a network entity is provided. The network entity comprises a processor configured such that the network entity receives a message that indicates that a sender of the message is an RCS client, the message including a list of the sender's client capabilities and a list of contacts about whom the sender wishes to receive presence-related information, the processor further configured such that the network entity establishes a presence context based on the sender being an RCS client and on the list of client capabilities and contacts of the sender, the processor further configured such that the network entity uses the presence context to monitor events in a network, and the processor further configured such that the network entity conveys information regarding the monitored events to at least one device in the network.

In another embodiment, a method for communicating service capability information is provided. The method comprises receiving, by a network entity, from a sender, a registration message containing information regarding a service capability of the sender and storing, by the network entity, the information, wherein the sender makes use of an RCS service. The registration message includes contact information of the sender. The registration message includes a duration for which the sender is reachable, and the registration message further includes one or more of a list of contacts of the sender or a reference that identifies a location of contact information for the sender.

In another embodiment, a computer readable medium is provided that contains instructions that, when executed by a processor, cause a network entity to receive a message that indicates that a sender of the message is an RCS client, wherein the messages includes a list of the sender's client capabilities and a list of contacts about whom the sender wishes to receive presence-related information, and further to cause the network entity to establish a presence context based on the fact that the sender is an RCS client and on the list of client capabilities and contacts of the sender, the network entity to use the presence context to monitor events in a network, and wherein the network entity to convey information regarding the monitored events to at least one device in the network.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for communicating service capability information, the method comprising:
receiving, by a network entity, a message that indicates that a sender of the message is a Rich Communication Suite (RCS) client and wherein the message includes a list of the sender's client capabilities and a list of contacts about whom the sender wishes to receive presence-related information;
establishing, by the network entity, a presence context based on the sender being an RCS client and the list of client capabilities and contacts of the sender;
using, by the network entity, the presence context to monitor events in a network; and
conveying, by the network entity, information regarding the monitored events to at least one device in the network.

2. The method of claim 1, wherein the message is one of a registration message and an options message.

3. The method of claim 1, wherein the list of contacts is specified by at least one of:
a uniform resource identifier (URI) encoded in an extensible markup language (XML) body;
a session initiation protocol (SIP) header;
a SIP header parameter; or
a feature tag.

4. The method of claim 1, wherein the list of contacts is specified by a location of contact information for the sender, and wherein the location of contact information for the sender is a fully qualified domain name encoded as at least one of:
an XML body;
a SIP header;
a SIP header parameter; or
a feature tag.

5. The method of claim 1, wherein the network entity sends to the sender capability information associated with at least one contact of the sender.

6. The method of claim 1, further comprising:
receiving, by the network entity, a message from the sender requesting information regarding service capabilities of at least one contact of the sender; and
transmitting, by the network entity, a message to the sender containing the requested information.

7. The method of claim 6, wherein the message requesting information regarding service capabilities is received responsive to the sender not receiving service capability information in response to sending the message.

8. The method of claim 1, further comprising:
transmitting, by the network entity, a message to the sender updating the information regarding the service capabilities of the at least one contact of the sender.

9. The method of claim 1, wherein the network entity is in an internet protocol multimedia subsystem (IMS) core network.

10. The method of claim 1, wherein the network entity extends the rich communication suite (RCS) capability discovery functions of a network interworking function.

11. The method of claim 1, further comprising providing the information regarding the service capability of the sender to a peer of the sender responsive to the peer engaging in communication with the sender.

12. The method of claim 1, wherein, when the registration message does not include contact information associated with the sender, the network entity retrieves capability information for a previously known set of contacts associated with the sender.

13. The method of claim 1, wherein the network entity communicates the service capability information via a presence access layer.

14. The method of claim 1, wherein the network entity, responsive to detecting that a device is no longer registered with a network, initiates an action on behalf of an active RCS client in the network.

15. A network entity comprising:
a processor configured such that the network entity receives a message that indicates that a sender of the message is a Rich Communication Suite (RCS) client, the message including a list of the sender's client capabilities and a list of contacts about whom the sender wishes to receive presence-related information, the processor further configured such that the network entity establishes a presence context based on the sender being an RCS client and on the list of client capabilities and contacts of the sender, the processor further configured such that the network entity uses the presence context to monitor events in a network, and the processor further configured such that the network entity conveys information regarding the monitored events to at least one device in the network.

16. The network entity of claim 15, wherein the message is one of a registration message and an options message.

17. The network entity of claim 15, wherein the list of contacts is specified by at least one of:
a uniform resource identifier (URI) encoded in an extensible markup language (XML) body;
a session initiation protocol (SIP) header;
a SIP header parameter; or
a feature tag.

18. The network entity of claim 15, wherein the list of contacts is specified by a location of contact information for the sender, and wherein the location of contact information for the sender is a fully qualified domain name encoded as at least one of:
an XML body;
a SIP header;
a SIP header parameter; or
a feature tag.

19. The network entity of claim 15, wherein the network entity sends to the sender capability information associated with at least one contact of the sender.

20. The network entity of claim 15, wherein the network entity receives a message from the sender requesting information regarding service capabilities of at least one contact of the sender and transmits a message to the sender containing the requested information.

21. The network entity of claim 20, wherein the message requesting information regarding service capabilities is received responsive to the sender not receiving service capability information in response to sending the message.

22. The network entity of claim 15, wherein the network entity transmits a message to the sender updating the information regarding the service capabilities of the at least one contact of the sender.

23. The network entity of claim 15, wherein the network entity is in an internet protocol multimedia subsystem (IMS) core network.

24. The network entity of claim 15, wherein the network entity extends the rich communication suite (RCS) capability discovery functions of a network interworking function.

25. The network entity of claim 15, wherein the network entity provides the information regarding the service capability of the sender to a peer of the sender responsive to the peer engaging in communication with the sender.

26. The network entity of claim 15, wherein, when the registration message does not include contact information associated with the sender, the network entity retrieves capability information for a previously known set of contacts associated with the sender.

27. The network entity of claim 15, wherein the network entity communicates the service capability information via a presence access layer.

28. The network entity of claim 15, wherein the network entity, responsive to detecting that a device is no longer registered with a network, initiates an action on behalf of an active RCS client in the network.

29. A method for communicating service capability information, the method comprising:
receiving, by a network entity, from a sender, a registration message containing information regarding a service capability of the sender; and
storing, by the network entity, the information,
wherein the sender makes use of an RCS service, the registration message includes contact information of the sender, the registration message includes a duration for which the sender is reachable and the registration message further includes one or more of:
a list of contacts of the sender or a reference that identifies a location of contact information for the sender.

30. A computer readable medium containing instructions that, when executed by a processor, cause a network entity to receive a message that indicates that a sender of the message is a Rich Communication Suite (RCS) client, wherein the messages includes a list of the sender's client capabilities and a list of contacts about whom the sender wishes to receive presence-related information, and further to cause the network entity to establish a presence context based on the fact that the sender is an RCS client and on the list of client capabilities and contacts of the sender, the network entity to use the presence context to monitor events in a network, and wherein the network entity to convey information regarding the monitored events to at least one device in the network.
